(19) United States
(12) Patent Application Publication
(10) Pub. No.: US 2016/0295426 A1
(43) Pub. Date: Oct. 6, 2016

(54) METHOD AND SYSTEM FOR COMMUNICATION NETWORKS

(71) Applicant: Nokia Solutions and Networks OY, Espoo (FI)

(72) Inventors: Eamonn GORMLEY, Bothell, WA (US); David James RYAN, Bothell, WA (US); Jeffrey Paul HARRANG, Bothell, WA (US)

(21) Appl. No.: 15/085,933

(22) Filed: Mar. 30, 2016

Related U.S. Application Data
(60) Provisional application No. 62/140,195, filed on Mar. 30, 2015.
(60) Provisional application No. 62/140,208, filed on Mar. 30, 2015.
(60) Provisional application No. 62/140,212, filed on Mar. 30, 2015.
(60) Provisional application No. 62/140,217, filed on Mar. 30, 2015.

(51) Int. Cl. H04W 24/02

(52) U.S. Cl. CPC H04W 24/02

(57) ABSTRACT

Fixed and variable phase transmissions can be used to reduce interference in a wireless communications system. Timing and location information can be provided over existing infrastructure in a building. Managed restoration of networks includes phasing-in network elements over time. Network elements may be aligned to a reference time source.

### CROSS-REFERENCES TO RELATED APPLICATIONS

The present disclosure claims priority to U.S. Provisional Application No. 62/140,195 filed Mar. 30, 2015, U.S. Provisional Application No. 62/140,208 filed Mar. 30, 2015, U.S. Provisional Application No. 62/140,212 filed Mar. 30, 2015, and U.S. Provisional Application No. 62/140,217 filed Mar. 30, 2015, all of which are incorporated by reference herein for all purposes.

### BACKGROUND

In order to serve the increased demand, wireless communication networks are becoming more diverse and complex, and subsequently are becoming more difficult to manage. A Self-Organizing Network (SON) simplifies and automates multiple processes to efficiently manage diverse communication networks.

Many SON algorithms require information about the coverage areas of cells in order to make better optimization decisions. However, it can be difficult to obtain cell coverage information for a network. Cell coverage information could be retrieved from the output of a network planning tool, but this information is not always available to a SON tool. In addition, network planning tools tend to use large amounts of data to determine cell coverage, so planning tools tend to be relatively slow and inefficient.

### BRIEF SUMMARY

Embodiments of this disclosure provide a method and a system for automatically adapting the parameters of a wireless network.

### BRIEF DESCRIPTION OF THE DRAWINGS

FIG. 1 illustrates a wireless communications system according to an embodiment.

FIG. 2 illustrates a network resource controller according to an embodiment

FIG. 3 illustrates an embodiment of a communications system.

FIG. 4 illustrates an embodiment of a process for managed service restoration.

FIG. 5 illustrates an embodiment of a system for in-building distribution of timing and location information.

FIG. 6 illustrates another embodiment of a system for in-building distribution of timing and location information.

FIG. 7 illustrates another embodiment of a system for in-building distribution of timing and location information.

FIG. 8 shows an embodiment of power line retransmission.

FIG. 9 shows an example of synchronized timing between base stations.

FIG. 10 shows an example of unsynchronized timing between base stations.

FIG. 11 shows a network of base stations that are synchronized to a master time reference source.

FIG. 12 shows an embodiment of a system for synchronizing events in a wireless network.

FIG. 13 shows a process for synchronizing events in a wireless network.

FIG. 14A and FIG. 14B show examples of two signals with different power levels being received at a mobile station receiver.

FIG. 15 shows a plot of power gain and loss of combined signals.

FIG. 16 shows the gain vs. phase difference when there is a 3dB imbalance in the signal levels arriving at the receiver.

FIG. 17 shows an embodiment of a different precoding matrix in each TTI from an interference source.

FIG. 18 shows an embodiment of a same precoding matrix in each TTI from an interference source.

FIG. 19 shows an embodiment of a same precoding matrix in each TTI from an interference source.

### DETAILED DESCRIPTION OF THE INVENTION

A detailed description of embodiments is provided below along with accompanying figures. The scope of this disclosure is limited only by the claims and encompasses numerous alternatives, modifications and equivalents. Although steps of various processes are presented in a particular order, embodiments are not necessarily limited to being performed in the listed order. In some embodiments, certain operations may be performed simultaneously, in an order other than the described order, or not performed at all.

Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

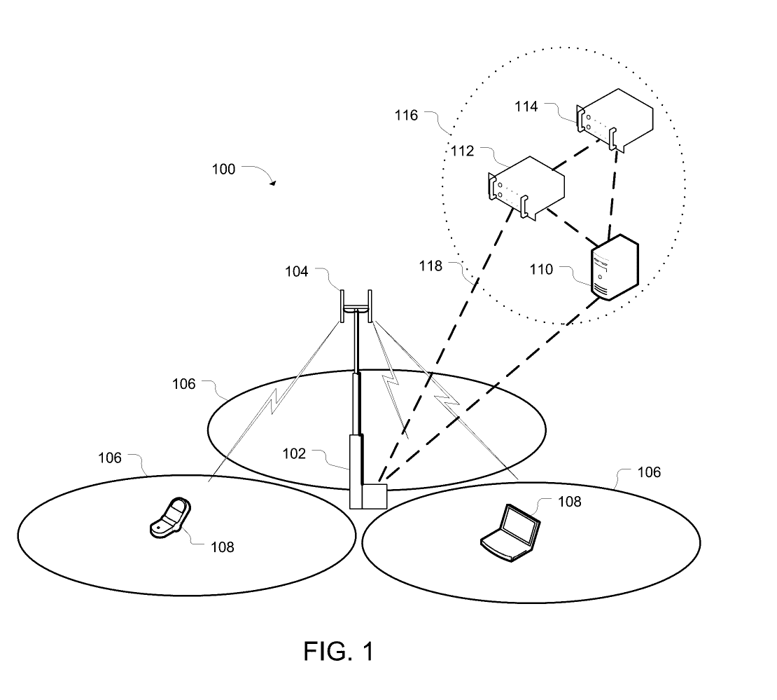

FIG. 1 illustrates a networked communications system 100 according to an embodiment of this disclosure. System 100 may include one or more base stations 102, each of which are equipped with one or more antennas 104. Each of the antennas 104 may provide wireless communication for user equipment 108 in one or more cells 106. As used herein, the term “base station” refers to a wireless communications station provided in a location and serves as a hub of a wireless network. For example, in LTE, a base station may be an eNodeB. The base stations may provide service for macrocells, microcells, picocells, or femtocells. In this disclosure, the term “cell site” may be used to refer to the location of a base station.

The one or more UE 108 may include cell phone devices, laptop computers, handheld gaming units, electronic book devices and tablet PCs, and any other type of common portable wireless computing device that may be provided with wireless communications service by a base station 102. In an embodiment, any of the UE 108 may be associated with any combination of common mobile computing devices (e.g., laptop computers, tablet computers, cellular phones, handheld gaming units, electronic book devices, personal music players, MiFi™ devices, video recorders, etc.), having wireless communications capabilities employing any common wireless data communications technology, including, but not limited to: GSM, UMTS, 3GPP LTE, LTE Advanced, WiMAX, etc.

The system 100 may include a backhaul portion 116 that can facilitate distributed network communications between backhaul equipment or network controller devices 110, 112 and 114 and the one or more base station 102. As would be understood by those skilled in the Art, in most digital communications networks, the backhaul portion of the network may include intermediate links 118 between a backbone of the network which are generally wire line, and sub networks or base stations located at the periphery of the network. For example, cellular user equipment (e.g., UE 108) communicating with one or more base station 102 may constitute a local sub network. The network connection between any of the base stations 102 and the rest of the world may initiate with a link to the backhaul portion of a provider's communications network (e.g., via a point of presence).

In an embodiment, the backhaul portion 116 of the system 100 of FIG. 1 may employ any of the following common communications technologies: optical fiber, coaxial cable, twisted pair cable, Ethernet cable, and power-line cable, along with any other wireless communication technology known in the art. In context with various embodiments, it should be understood that wireless communications coverage associated with various data communication technologies (e.g., base station 102) typically vary between different service provider networks based on the type of network and the system infrastructure deployed within a particular region of a network (e.g., differences between GSM, UMTS, LTE, LTE Advanced, and WiMAX based networks and the technologies deployed in each network type).

Any of the network controller devices 110, 112 and 114 may be a dedicated Network Resource Controller (NRC) that is provided remotely from the base stations or provided at the base station. Any of the network controller devices 110, 112 and 114 may be a non-dedicated device that provides NRC functionality among others. In another embodiment, an NRC is a Self-Organizing Network (SON) server. In an embodiment, any of the network controller devices 110, 112 and 114 and/or one or more base stations 102 may function independently or collaboratively to implement processes associated with various embodiments of the present disclosure.

In accordance with a standard GSM network, any of the network controller devices 110, 112 and 114 (which may be NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UMTS network, any of the network controller devices 110, 112 and 114 (optionally having NRC functionality) may be associated with a NRC, a serving GPRS support node (SGSN), or any other common network controller device known in the art, such as an RRM. In accordance with a standard LTE network, any of the network controller devices 110, 112 and 114 (optionally having NRC functionality) may be associated with an eNodeB base station, a mobility management entity (MME), or any other common network controller device known in the art, such as an RRM.

In an embodiment, any of the network controller devices 110, 112 and 114, the base stations 102, as well as any of the UE 108 may be configured to run any well-known operating system, including, but not limited to: Microsoft® Windows®, Mac OS®, Google® Chrome®, Linux®, Unix®, or any mobile operating system, including Symbian®, Palm®, Windows Mobile®, Google® Android®, Mobile Linux®, etc. Any of the network controller devices 110, 112 and 114 or any of the base stations 102 may employ any number of common server, desktop, laptop, and personal computing devices.

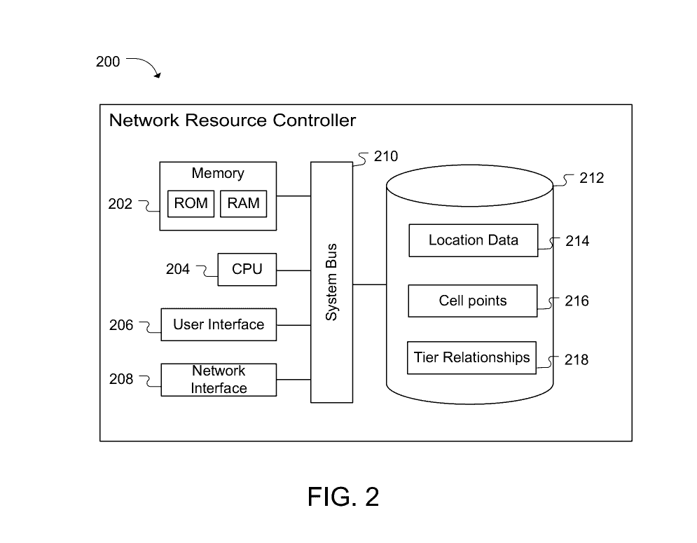

FIG. 2 illustrates a block diagram of an NRC 200 that may be representative of any of the network controller devices 110, 112 and 114. Accordingly, NRC 200 may be representative of a Network Management Server (NMS), an Element Management Server (EMS), a Mobility Management Entity (MME), or a SON server. The NRC 200 has one or more processor devices including a CPU 204.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, location data 214, cell points 216, and tier relationships 218.

The NRC 200 may also include a user interface 206 that allows an administrator to interact with the NRC's software and hardware resources and to display the performance and operation of the system 100. In addition, the NRC 200 may include a network interface 208 for communicating with other components in the networked computer system, and a system bus 210 that facilitates data communications between the hardware resources of the NRC 200.

In addition to the network controller devices 110, 112 and 114, the NRC 200 may be used to implement other types of computer devices, such as an antenna controller, an RF planning engine, a core network element, a database system, or the like. Based on the functionality provided by an NRC, the storage device of such a computer serves as a repository for software and database thereto.

### Managed Service Restoration In Packet Data Networks

Following major service outages, networks are brought back into service in an orderly, phased manner that avoids overloading shared network resources and consequent service restoration inefficiency. Rates of service restoration can be throttled via load monitors on critical resources.

Modern packet data access networks often provide service to thousands or millions of end users in extensive metro or regional service areas. A key performance indicator for the network is the rate at which it recovers following a major outage such as one caused by wide area power failure affecting a large number of end users.

With major outages the issue is the initial high volume of network reentry transactions that often dwarfs the steady-state transaction rate. This initial traffic surge stresses network resources and can result in deep queuing or dropping of requests and consequent timeout/retry cycles. In extreme cases this results in networks that achieve a deadlocked state where recovery can only be achieved by manually disabling portions of the user equipment population in order to allow other portions to reenter first, thereby limiting the total reentry traffic volume to manageable levels.

Current practices requiring manual intervention are slow, costly, error-prone, and sub-optimal. What is required are ways of automating procedures for rapid orderly recovery while not over-burdening critical network resources involved in reentry procedures.

Embodiments of the present disclosure include a system and methods by which one or more cooperating network element controllers orchestrate the timing when key network elements are allowed to reenter the network following a major outage affecting a threshold number of elements such as user equipment terminals.

The network element controllers follow a predetermined script of the sequence of which elements are allowed to reenter and the rate at which the sequence is followed. The result is that the initial free-for-all flood of network reentry requests is bounded to a manageable level.

In an embodiment, the pacing of the rate of reentry is dynamic. This is accomplished by throttling the reentry script execution rate based on how heavily or lightly key network resources are loaded. The load measurements are fed back to the network element controllers for use in determining the optimal pacing (slower when high load, faster when low load). In this way the rate of network recovery tends to proceed as quickly as the network can allow without having to slow the overall process with pre-configured worst-case guesses and built-in safety margins.

Another feature of an embodiment is intentionally forcing distributed network elements into an off-line or non-operational state such that they can be systematically reintroduced to the network in a controlled manner.

In the following portion of this disclosure, two use case scenarios are explained for the purpose of illustrating the operation of various embodiments.

In a first use case, a regional access network services a metro area that suffers a power black-out. When power is restored the user terminals and access network infrastructure (e.g. wireless base stations) would otherwise all simultaneously attempt to rejoin the network. However, according to an embodiment of this disclosure, a network controller coordinates network reentry attempts so that overall network service is restored without excessively burdening key resources that would otherwise become overloaded. Service is rapidly restored to the entire network within a defined time interval.

The controlled reentry coordination optionally force the wireless access node (i.e. wireless base station) into a non-operational state in a sequence thereby forcing all subordinate user equipment into similar idle states pending the systematic re-start of each access node per the methods described in this invention.

The access network operator is able to monitor the progress of the otherwise autonomous process and manually intervene if desired. Otherwise, network service may be restored without manual operator intervention, minimizing the burden on the operator and limiting the service outage inconvenience to their customers.

An additional benefit is that key bottleneck resources to network reentry can be sized for lower peak load since the managed reentry procedure limits the peak load to a lower bounded value than would otherwise be the case without the controlled reentry.

In a second use case, a regional access network services a metro area using critical network elements that control the network connectivity of a large number of user equipment terminals. In many cases, software or hardware failure or reset of critical core network elements (e.g. serving gateways or mobility management nodes) results in loss of dynamic user equipment permissions and essential registration—session context data. However in general the individual user equipment elements will continue to receive wireless signals of sufficient quality without knowledge of the critical core network. This creates a situation where user terminals drop and reestablish their network connection status.

To avoid potentially uncontrolled user equipment re-registration and re-association data messaging, an embodiment may sequentially force the wireless access node (e.g. wireless base station) into a non-operational state thereby forcing all subordinate user equipment into similar idle states pending the systematic re-start of each access node according to processes described in this disclosure.

In an embodiment, additional network probes are in place to monitor key resource load levels associated with network entry procedures. The information coming from the probes is used by the network controller to speed up and slow down the pace of the coordinated network reentry sequencing which improves the overall network restoration time to an optimally short interval minimizing end user service outage time.

In such an embodiment, the access network operator is able to monitor the progress of the otherwise autonomous process and manually intervene if desired. Otherwise network service is restored at an optimal rate without requiring manual operator intervention.

In an embodiment, the ordered sequence at which key network elements are allowed to reenter the network after service outage is paced at a predetermined rate.

In an embodiment, a network controller maintains a sequential list of the portions of the network to bring online as specified by the network elements that manage them (e.g. an access point or base station in a wireless network). The list consists of network element names specifying their network address and connection information as well as the command scripts required to bring the element online.

A process managed by the network controller watches the operation of the network and detects abnormal activity indicating large scale service outage events. For example the following are examples of three events that could trigger detection of a service outage: 1) floods of alarms from location (topology) correlated network infrastructure elements detecting sudden mass user terminal disconnections or handover attempts, 2) disaster alarms triggered by earthquakes, storms, floods, fires, and 3) regional power failure or brown-out alarms.

On detecting a mass outage the network controller attempts to place the affected portions of the network into ‘safe mode’ defined by placing the last-mile coverage element (e.g. access point, base station, etc.) into standby state so that network attachment requests are detected but ignored. In cases where the infrastructure element is affected by the same outage it will come back into safe mode when the outage is cleared.

When the fault that caused the service outage is cleared the user equipment terminals would otherwise all begin a mass attempt to rejoin the network. Because the coverage network elements are in safe mode, the attempts are detected but initially ignored and not passed deeper into the network core.

In an embodiment, the network controller detects that the service outage fault has been cleared either by automated or manual means. This triggers a process run by the network controller where the segments of the network in safe mode are selectively re-enabled. Pre-configured wait intervals between the re-enable commands throttle the total number of network reentry attempts and avoid overloading key bottleneck network resources that are used in the reentry procedures of the user equipment terminals.

Once the network service is restored the process terminates and the outage detection routine begins again.

An embodiment may be explained according to four primary phases of operation: 1) Outage detection, 2) Outage recovery detection, 3) Managed network restoration, and 4) Normal operation.

In the first phase one or more network elements monitor the network, and periodically query or receive reports from network infrastructure elements as to their health and status. Monitored elements may include gateways, base station controllers, base station, traffic concentration nodes and user equipment terminals. This capability relates to network management typically found in large packet data networks.

Outages are detected when correlated groups of alarms and performance metric trends indicate a region of the network is experiencing a service outage (e.g., power failure taking a group of user equipment terminals offline). Outages might equally be detected via external means or manually based on broadcast emergency alerts or observations (e.g., an earthquake).

For the purposes of this invention, criteria defining an outage would include a minimum number of affected end users all sharing common bottleneck resources that would be involved in restoring network connectivity to the users.

In one aspect of outage detection, the network elements first in line to respond to network entry requests from user end terminals are placed into safe mode if possible (e.g. if they are still functional).

In the second phase the source of the outage is cleared and the event is detected via the network management system. Outage recovery is detected when correlated groups of alarms and performance metrics indicate a network region is capable of having service restored (e.g., power restoration).

Outage recovery detection may be autonomous or manual and triggers the next phase in the process.

In the third phase service is incrementally restored to user equipment terminals in portions of the affected network in a pre-configured scripted sequence that bounds the number of user equipment terminals that attempt to reenter the network at a time. After each network portion is restored the next portion is selected and the process continues until the entire network outage affected region is recovered.

In the final phase normal network operation is restored and the process of monitoring the health of the network resumes.

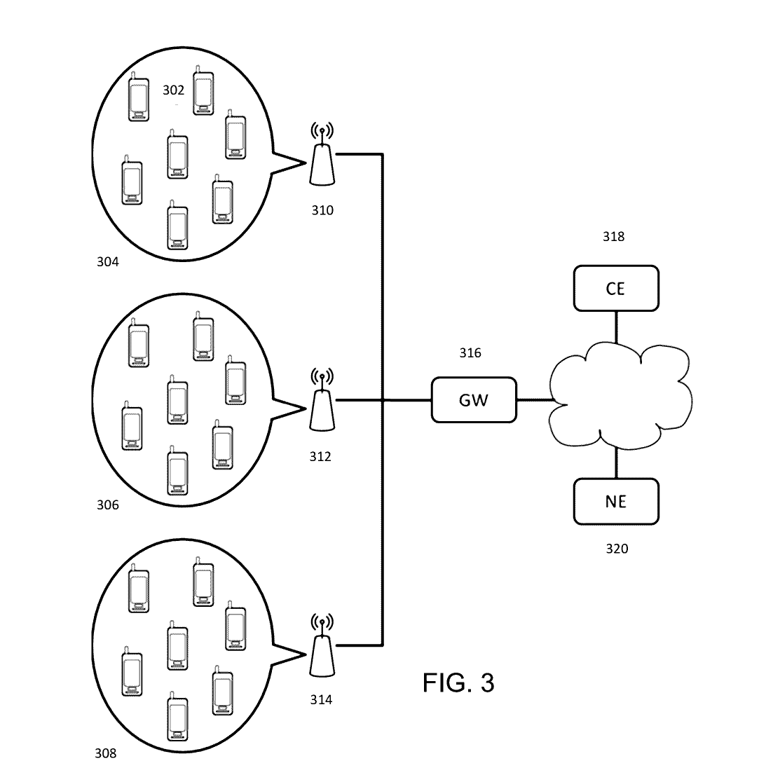

FIG. 3 illustrates an embodiment of a wireless network including of internetworked core elements 316, 318 and 320 connecting a plurality of base stations 310, 312 and 314 providing network connectivity to a plurality of user equipment terminals 302 in coverage areas 304, 306, 308 corresponding to a base station.

In an embodiment, the core network consists of one or a plurality of concentration gateways 316, a controller element 318 and a plurality of network elements 320 coupled to a backhaul of the network that are key resources involved with network entry by the user equipment (e.g., AAA servers, database servers, policy and charging servers, IP services servers). It is understood that the gateway and base station elements are also integral to the network entry process.

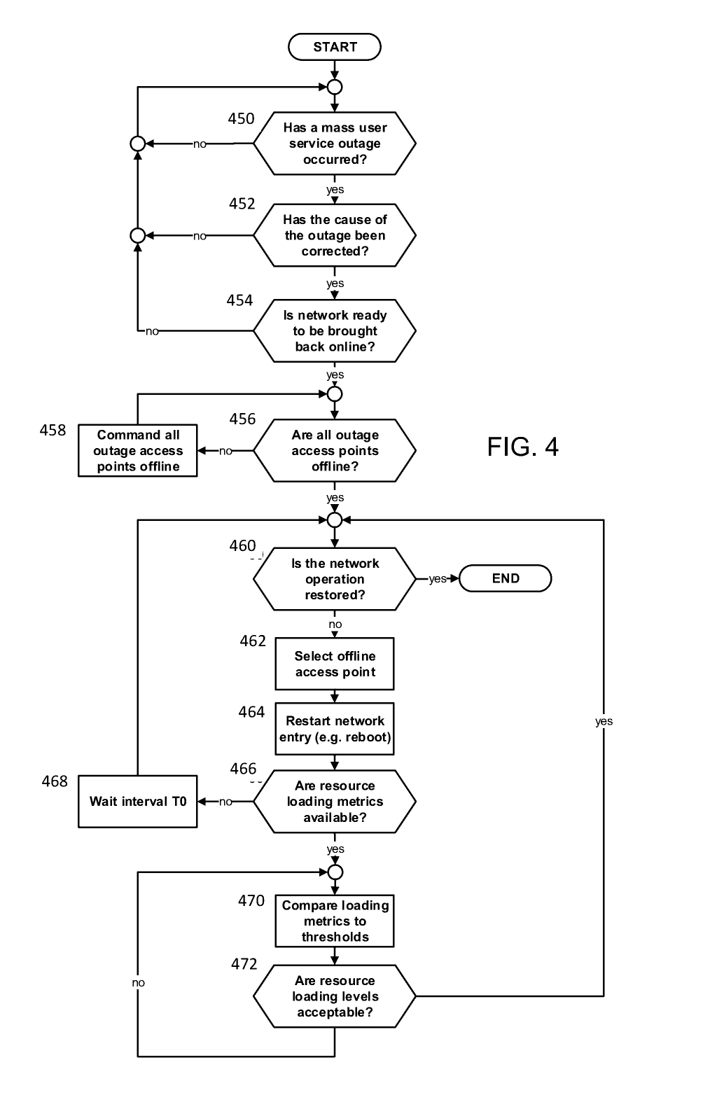

FIG. 4 illustrates a process according to an embodiment. Elements of the process may be performed by the control element 318 of FIG. 3, or the NRC of FIG. 2.

The process begins with an outage determination process 450. If an outage has not occurred the process loops to the beginning.

When an outage is detected, the process determines at 452 whether the cause of the outage has been cleared. If the outage cause has not been corrected the process loops to the beginning.

If the outage cause has been cleared the process determines at 454 whether the network is ready to be brought back into service or not. If the decision is that the network is not ready the process loops to the beginning.

If the network is ready to be brought back into service the process determines at 456 where all network elements closest in network topology to the user equipment terminals are verified to be offline in safe mode and placed into safe mode if they are not already at 458. In some embodiments this involves placing the user equipment terminals themselves into safe mode. In other embodiments this involves placing the first forwarding network element connecting the user equipment terminals into safe mode.

Next the process determines at 460 where the network is check to determine whether it is back in normal operation. If it is, the process ends.

If the network is not back in service an offline (safe mode) network element is selected from a pre-configured list at 462. Next at 464, the selected network element and associated user equipment terminals are enabled to permit the user equipment network entry requests to flow to the core network. This may be done in an embodiment by rebooting the selected network element or otherwise taking it out of safe mode.

Next, if loading metrics are not available to the control element, the process waits a pre-determined interval T0 at 468 before looping back to determine if full service has been restored to the network. The interval T0 is configured to allow sufficient time for the user equipment terminals to reenter the network. In some scenarios this time could be configured to be proportional to the number of user equipment terminals covered by the network element selected in step 462.

If loading metrics are available to the control element, the process compares loading metrics to a preconfigured threshold at 470. For example in an embodiment a AAA server might have a CPU usage threshold of 50% occupied. In some embodiments there may be multiple metrics from multiple key network elements. In such embodiments a logical AND operation between all threshold conditions may determine whether the loading metrics are within acceptable limits.

If the resource loading metrics are not within acceptable limits the process loops back to the comparison step 470 until they are within acceptable limits. In a typical scenario this occurs when the monitored resources have nearly completed network entry of the portion of the network being restored.

If the resource loading metrics are within acceptable limits the process loops back to the beginning of the service restore process 460 and either exits if the entire network service is restored or selects at 462 the next portion of the network to restore service.

### In-Building Distribution of Timing and Location Information

This invention provides accurate timing, frequency, and/or location information to electronic equipment operating inside of buildings, underground or otherwise unable to directly access timing and location signals transmitted over wireless systems and available to equipment operated outdoors.

Many electronic devices require or would benefit from highly accurate synchronized timing, frequency, and/or location information. Examples include in-building wireless networking equipment such as wireless femtocells supporting commercial cellular or PCS band services, many of which use high levels of network timing synchronization (e.g., to sub microsecond levels) to minimize interference across the wireless network and to support mobility functions such as signal handover to neighboring base stations. Many of these systems also use accurate knowledge of the geographic location of each wireless base station to support network optimization and to support emergency calling or E911 requirements. Examples of consumer electronics equipment that would benefit from accurate indoor time and frequency information are any device that includes a time of day clock that could be automatically synchronized to regional and national standards as opposed to individually set to unknown accuracy by consumers.

There are several standardized ways of acquiring accurate timing, frequency and location information over outdoor wireless networks by electronics equipment, assuming the equipment can receive the desired reference signals with sufficient quality. Examples include GPS satellite signals which provide highly accurate time, frequency and location information through commonly available receiving equipment, and locally distributed timing information sent over proprietary networks such as timing information broadcast by nearby cell sites for the purpose of synchronizing indoor femtocells. Many of these systems are at a sufficiently high radio frequency or transmitted with sufficiently low signal strength that reception by equipment located within buildings, in underground parking garages and in other indoor locations is unreliable due to signal losses into the buildings or structures. Even the so-called ‘indoor GPS’ systems do not provide sufficient reliability across a wide range of building types or into tunnels, underground structures or other poor satellite signal quality environments.

The present disclosure provides a method for receiving timing, frequency and/or location information via receiving equipment located outside of a building and redistributing those signals to equipment located within the building.

An embodiment is directed to a system comprised of a timing, frequency and/or location receiver located externally to a building coupled to a retransmission system that redistributes the signal to equipment located within the building in a reliable manner.

Embodiments include externally mounted GPS receivers with a clear view of the sky receiving timing, frequency and location information from GPS satellites coupled to a local retransmission system that modulates the desired frequency, timing and location information onto the building's power wiring such that electronics equipment located within the building equipped with compatible power line receive circuitry would be able to receive the relevant information from their own power cabling. The frequency, timing and location information transmitted over the internal power line wiring can be in a different format to the GPS signaling itself.

Alternative retransmission schemes include local retransmission over relatively low power transmitters operating for example in FCC (or other regional authority) defined unlicensed bands or retransmission via unlicensed 802.11 WiFi networks. In these cases the proximity of the local retransmission system would result in increased signal quality at the end point electronics equipment receiver and increased reliability of overall timing, frequency and/or location information.

Embodiments are not limited to retransmission of GPS signals, although retransmission provides a convenient example as an embodiment could retransmit regionally distributed information signals to in-building equipment with benefits of increasing reception reliability and overcoming signal degradation to in-building equipment.

Embodiments of several example systems are shown in the following diagrams.

FIG. 3 shows an embodiment in which an externally mounted GPS receiver with a clear view of the sky acquires timing and location information from GPS satellites. This GPS receiver is powered via a standard outdoor electrical outlet connected to the building's AC wiring through the power line modulator and a data pre-processing device. The information of interest, for example the GPS 1 pulse per second timing reference and the latitude, longitude and elevation information obtained from the GPS signals is packaged for retransmission and then modulated onto the building's wiring by the power line modulator unit.

An implementation of this modulator function includes a differential low voltage, high frequency modulation of information onto the building's AC wiring hot and neutral pairs. This information would then be carried by existing home wiring to suitable electronics devices plugged into standard AC outlets within the building. These devices would contain compatible power line demodulator circuitry to receive, reconstruct and deliver the desired timing, frequency and/or location information to devices within the building. The information sent over the power line could be a synchronous signal with well defined timing, or an asynchronous signal containing packetized timing and location information, or a combination of both signal types.

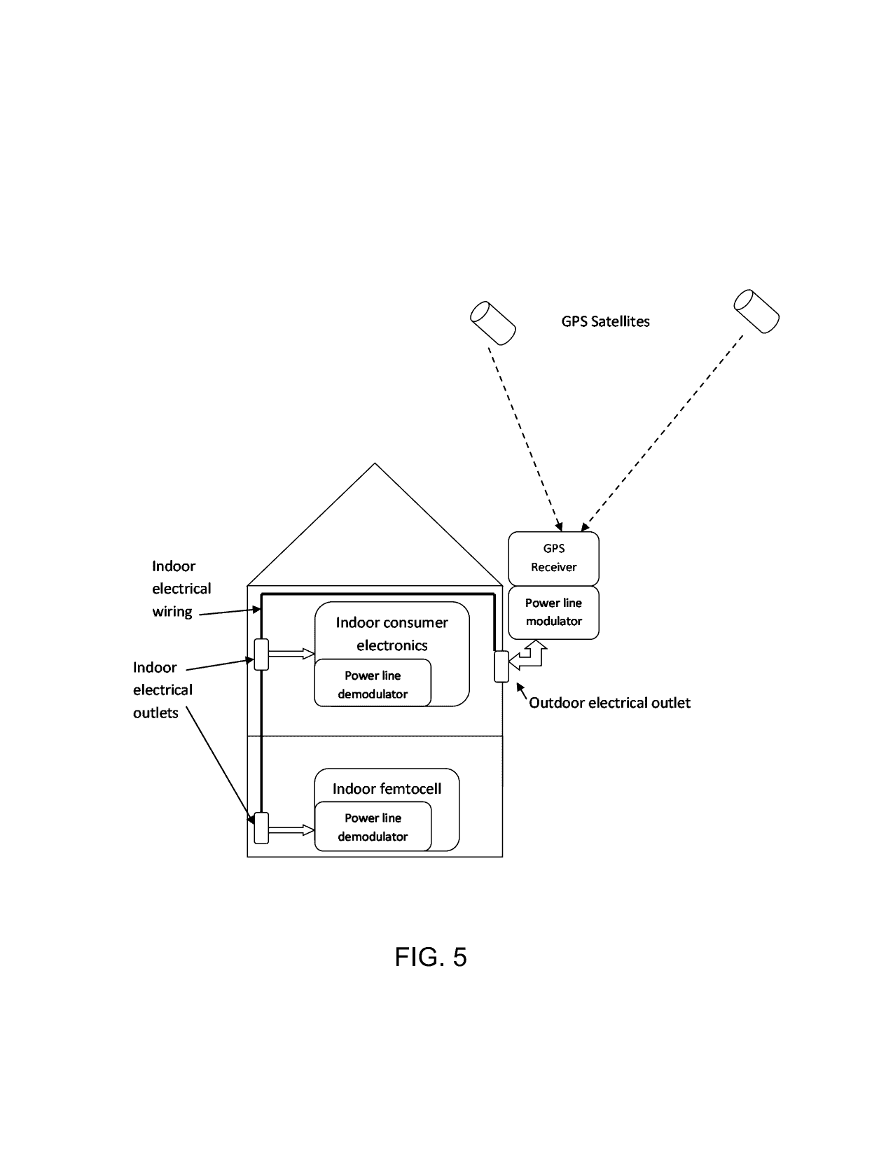

FIG. 5 illustrates both an indoor wireless femtocell and a consumer electronics device deriving timing and/or location information from the externally mounted GPS receiver via the building's power wiring. The wireless femtocells use this information to maintain tight timing synchronization with external cell sites to facilitate mobility handover and to minimize system interference resulting from unsynchronized base stations. The consumer electronics equipment shown in FIG. 5 could derive simple information such as accurate time of day for the purpose of clock displays or triggering time driven events such as initiating a recording of television programs at appropriate times.

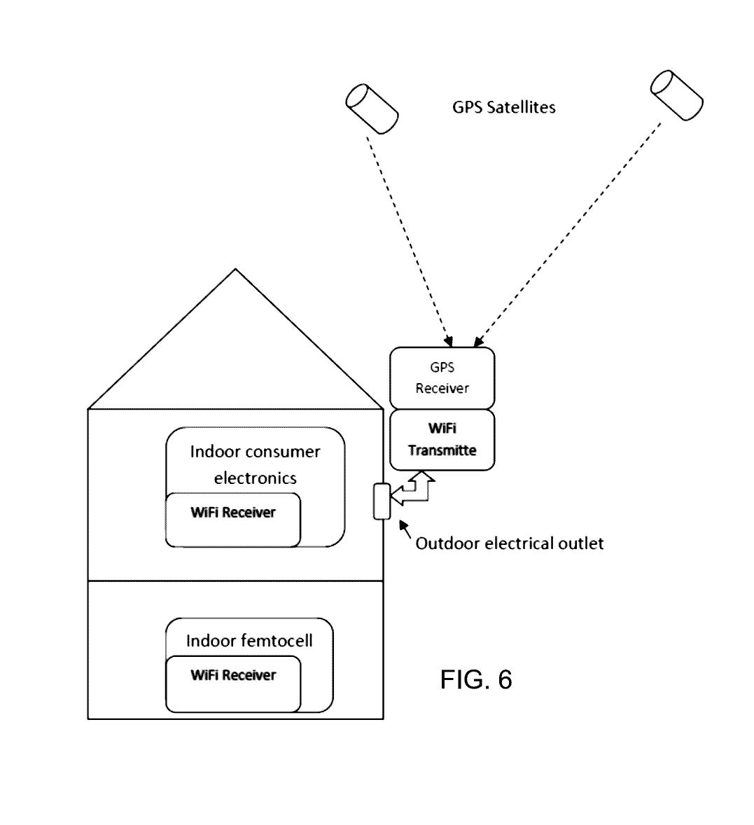

FIG. 6 illustrates an embodiment which utilizes commonly available WiFi transmissions to redistribute timing, frequency and/or location information from an externally mounted GPS receiver to indoor devices. With the exception of the local distribution method, other elements of the embodiment of FIG. 6 may be similar to the elements of FIG. 5 discussed above.

In an embodiment, specially formatted Ethernet packets are sent over the WiFi link.

These packets contain highly accurate timestamp and location information. The receiver device derives a highly accurate local timing signal from the timestamp contained in the received packets and knowledge of when the packets arrive at the receiver. The receiver device derives a highly accurate frequency reference from the inter-packet arrival time and averaging of the packet timestamps over multiple received packets. Examples of frequency reference derivation schemes that can be employed by the receiver include a phase locked loop with a voltage controlled oscillator (VCXO) to maintain frequency accuracy between packet arrivals, and a frequency locking scheme incorporating a fixed frequency oscillator in conjunction with direct digital synthesis (DDS) techniques.

In addition to WiFi as a delivery method, other local wireless transmission schemes including proprietary schemes utilizing licensed or unlicensed spectral bands could be used. For instance a proprietary local retransmission system utilizing unique spread spectrum codes and operating in appropriate unlicensed spectrum (e.g. FCC defined ISM bands) could be used to locally redistribute timing, frequency and/or location information with reduced risk of interference from nearby WiFi devices with an appropriately designed transmission scheme.

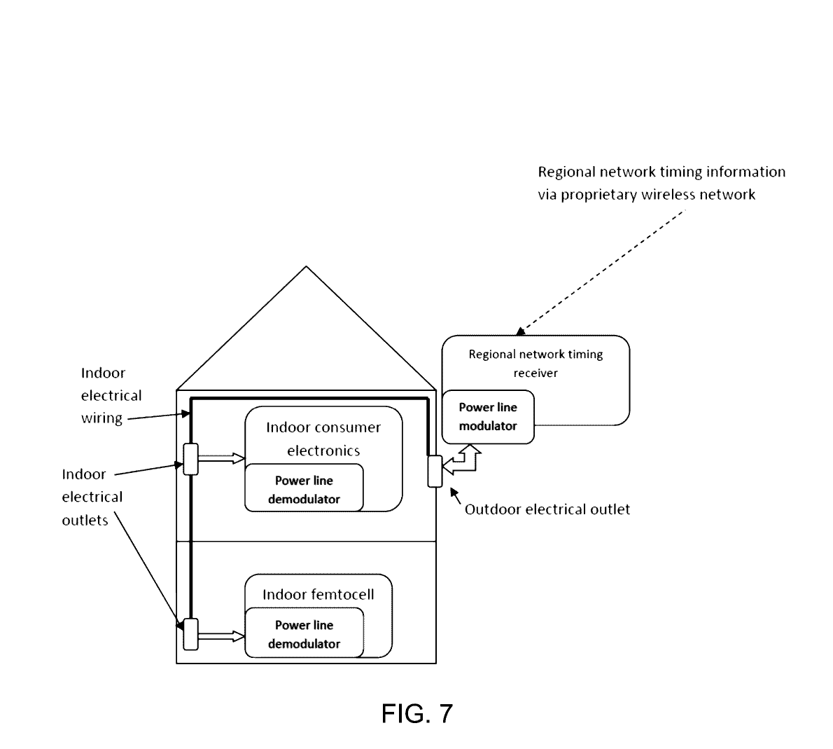

FIG. 7 illustrates a system receiving timing, frequency and/or location information from a source other than GPS such as a signal broadcast from local cellular sites specifically to facilitate synchronization of regional devices. In an embodiment a receiver capable of receiving National Bureau of Standards timing signals could be mounted to provide accurate time and/or frequency signals. FIG. 7 shows an outdoor receiver coupled to indoor electronics devices via a power line retransmission scheme as described for FIG. 5. In an embodiment the power line retransmission scheme could be replaced by a wireless retransmission system as illustrated in FIG. 6 while maintaining functionality.

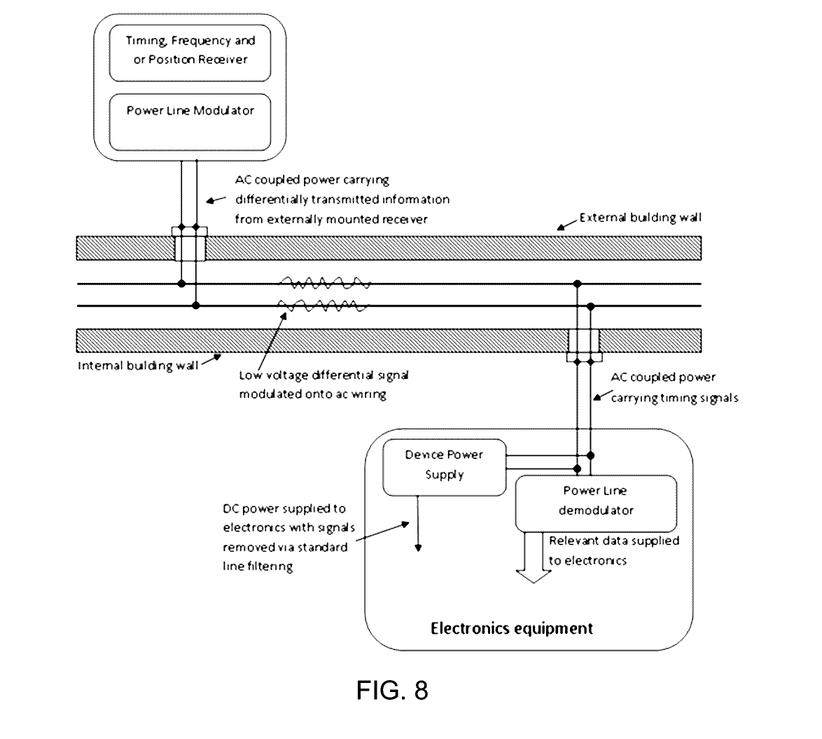

FIG. 8 illustrates a possible implementation of the power line retransmission scheme described in FIG. 5 and FIG. 7 which modulates low voltage differential signals onto existing building AC wiring for use by devices located inside the building.

An embodiment operates by placing a receiver outdoors where optimal radio frequency signal strength can be obtained without the additional losses associated with radio frequency signals penetrating buildings. This high reliability externally received information is then retransmitted into the building or structure via low power methods such that is localized to the building of interest.

Embodiments of this disclosure may have one or more of the following three components:
1) An external radio frequency receiver compatible with regional or global synchronization information such as GPS or proprietary synchronization transmission.
2) Circuitry that isolates the pertinent synchronization signals such as timing, frequency or location information and remodulates that information onto suitable local redistribution system such as building power lines, local WiFi transmitter or proprietary retransmission scheme.
3) Circuitry incorporated into indoor electronics equipment to receive synchronization information for use by said electronics equipment.

### Synchronizing Events in a Cellular Wireless Network

Cellular radio networks generally have strict requirements for the accuracy of the transmit frequencies on which the networks operate. For example, the radio interfaces of GSM and UMTS base stations have a frequency accuracy requirement of ±50 ppb (parts per billion).

Cellular radio networks may or may not have such strict requirements for the relative timing from base station to base station. In general, Time Division Duplexing (TDD) networks require synchronization of the airlink timing so that the downlink transmissions don't overlap with the uplink transmissions in time. In the case of UMTS TDD systems, the timing alignment of neighboring base stations should be within 2.5 us.

Frequency Division Duplexing (FDD) networks usually have no such requirement for their timing accuracy (as in the case of GSM and UMTS FDD networks). In such networks, the frame timing at one base station has no relation to the frame timing at other base stations. One notable exception to this is the CDMA2000 base station specifications (CDMA2000 is a FDD network). CDMA2000 base stations are required to be aligned to CDMA system time (synchronous to UTC time and using the same time origin as GPS time). The timing error for CDMA2000 base stations should be less than 3 us and shall be less than 10 us (ref 3GPP2 C.S0024-B, “cdma2000 High Rate Packet Data Air Interface Specification”).

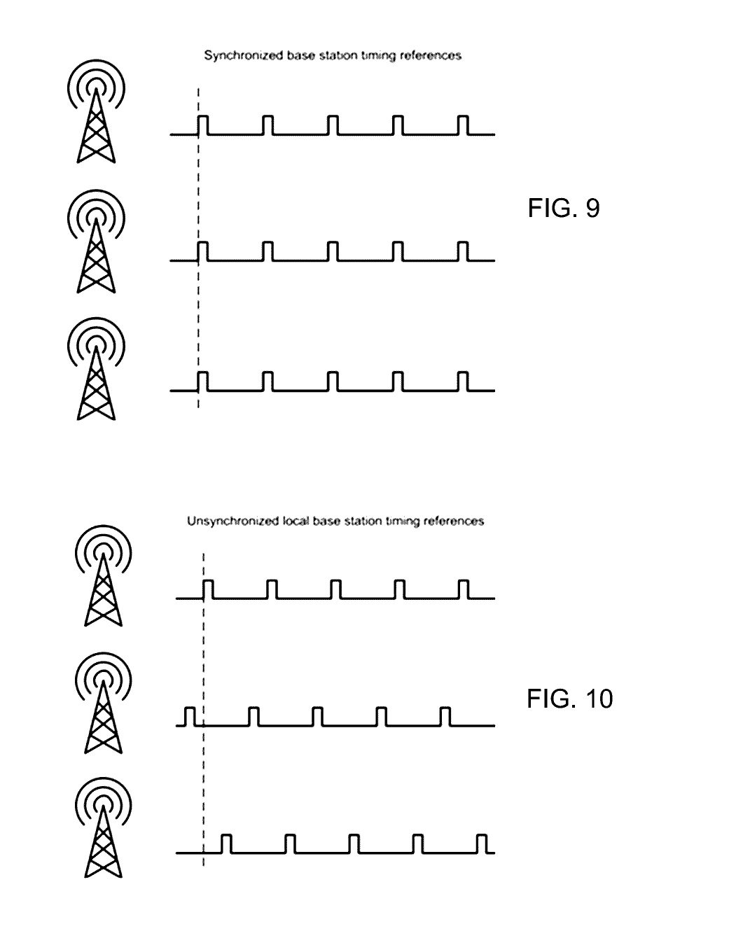

FIG. 9 shows an example of tight timing between base stations, such as may exist in a UMTS TDD or CDMA2000 network of base stations. The signals at each base station are synchronized in time.

FIG. 10 shows an example of base station timing that may exist in a GSM or UMTS FDD network of base stations. The timing references at each base station are randomly aligned in time.

For networks that have timing alignment requirements, it is relatively straightforward to schedule future events to occur on or about the same time throughout the network. An example of such a scheduled event is for automated interference detection. All base stations are instructed to establish a simultaneous ‘quiet time’, where the mobile devices in the network are instructed not to transmit. Such a quiet time could be used in the network to detect and locate external sources of co-channel interference. Another example of a scheduled event is a synchronized network parameter update, where the network parameter is scheduled to take effect at each base station at the same time.

For cellular networks where the base stations are not aligned in time to a common timing source, it is not feasible to schedule such synchronized events based on the local frame timing alone. Therefore, in order to enable synchronized events in such a network, it is desirable to establish a common timing reference across all the base stations.

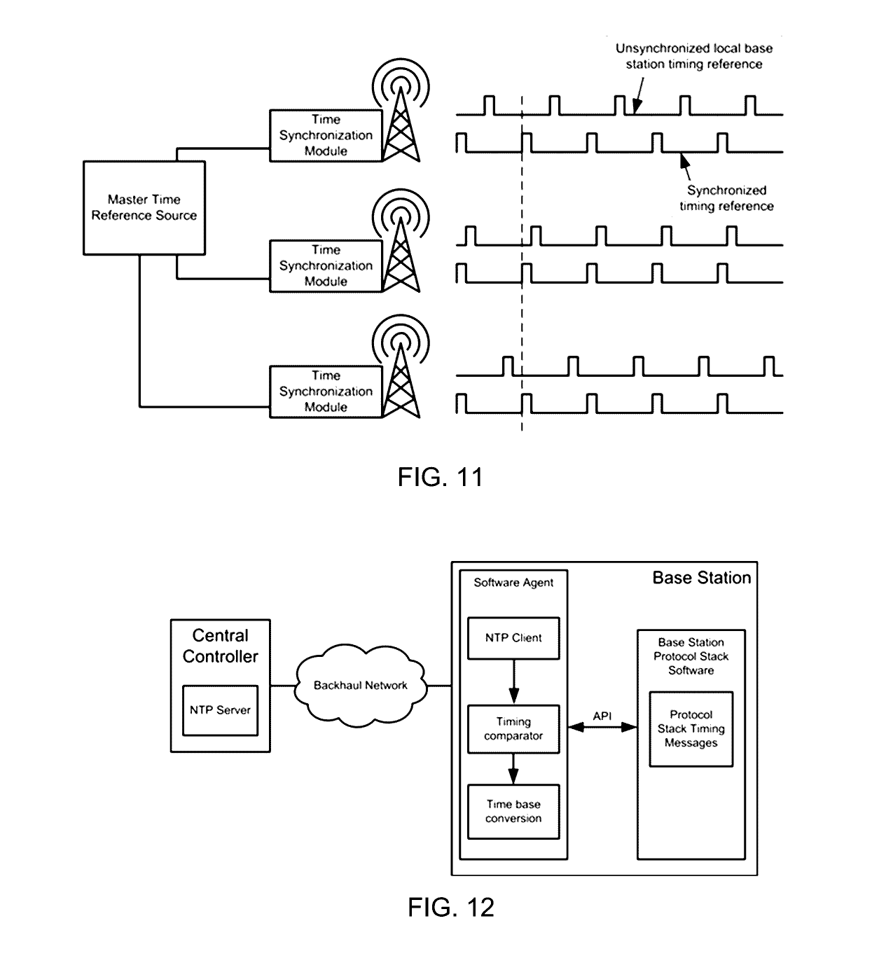

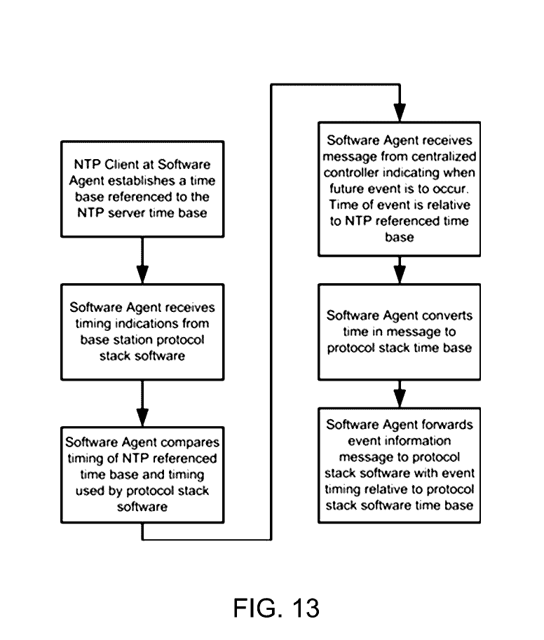

FIG. 11 shows a network of base stations that are synchronized to a master time reference source. A time synchronization module is located at each base station. This module receives timing signals from the master time reference source and generates a synchronized timing reference at the base station.

The time synchronization module may be an external timing module device that passes timing information to the base station over a standard timing interface (e.g., GPS Pulse Per Second, (PPS)). Some existing timing modules are a GPS master time reference with GPS receiver modules at each base station, and a timing module to extract timing passed over backhaul connections (e.g., T1, E1, Ethernet).

Hardware time synchronization modules can provide a very accurate timing signal to each base station, allowing time synchronization to within a few microseconds. One drawback with using hardware modules to establish a timing reference is the cost. Additionally, base stations that have already been deployed in the field may not have a provision for accepting an external timing signal. In such networks, hardware modules cannot be used to establish a common timing reference across the base stations in the network.

An alternate to pure hardware-based timing synchronization is to use time synchronization that is implemented by hardware as program instructions, or software. One commonly used protocol used over packet switched Internet Protocol (IP) links is the Network Timing Protocol (NTP). Depending on the latency variations over the packet data links in a network, NTP can establish a timing reference to within a few milliseconds, or less. This protocol is described in IETF RFC 1305 and RFC 5905. A less complex implementation of NTP also exists, known as the Simple Network Timing Protocol (SNTP), described in RFC 4330. SNTP is described as a subset of NTP.

Another protocol that spans the hardware and software domains is the Precision Timing Protocol (PTP), standardized as IEEE 1588. PTP can achieve sub-microsecond timing alignment. However, it makes use of hardware timestamps applied at the physical layer at each end of a connection—hence the base station Ethernet interfaces would already have to support such time stamping, which is generally not the case. PTP is generally suited for deployment over a local area network and may not be applicable over the backhaul networks connecting multiple base stations.

An embodiment of this disclosure includes a method of establishing a common time base across a network of cellular base stations. FIG. 12 shows a high level diagram of an embodiment.

A software agent is deployed at each base station. The software agent may include software that sits between the base station protocol stack software and a central controller. The software agent can be supplied by a third party to the base station software vendor.

As shown in FIG. 12, the software agent may include an instance of the Network Timing Protocol (NTP). The software agent uses NTP to establish a time base reference with a NTP server. This time base is not shared with other software or hardware at the base station and is known only to the software agent. While the NTP time synchronization mechanism may not permit synchronization to the same degree of alignment as hardware based solutions, they can be used in cases where it is acceptable that the events at each base station be synchronized to within a few milliseconds of each other.

The software agent also communicates with the existing base station protocol stack over an Application Programming Interface (API). The existing base station protocol stack provides periodic timestamps to the Agent over the API. In this manner, the software agent learns the time base used by the base station protocol stack software. Note that in this description, we use the term base station protocol stack software to encompass all the non-Agent software that resides at the base station.

The software agent also incorporates a process that compares the relative timing between the time base established by the software agent with the NTP server, and the time base communicated by the base station protocol stack over the software agent API. The output of the comparison block is fed into a time base conversion block. The time base conversion block converts the timing information from one time base to the other time base.

A centralized controller informs the software agent when to schedule an event. The centralized controller schedules the event to occur at or about the same time at multiple base stations by sending messages to multiple base station agents, informing them all of the time at which the event is to occur. The time indicated in the message sent by the centralized controller is relative to the NTP server time, which is the same as the time base established at the software agents at each base station.

When the software agent at each base station receives the message from the centralized controller, it converts the event time contained in the message from the synchronized time base to the time base used by the base station protocol stack. Even though the time base of the protocol stack software at each base station is different, each of them will schedule the event to occur at the same absolute time.

In some implementations, the centralized controller can also act as the NTP time server, as shown in FIG. 12. In other instances, the centralized controller and NTP time server are implemented on different machines. In this case, the centralized controller can also establish a common time base with the base station software agents by including an NTP client that synchronizes with the NTP server.

In an embodiment, it is not necessary to change the time base used by the protocol stack software at each base station. Instead, a translation process is used to convert between the common time base established at each of the software agents in the network and the local time base used by the base station protocol stack software at each base station.

### Method of Intercell Interference Reduction Via Fixed/Variable Phasing of Base Station Transmissions

Embodiments of the present disclosure include a process that reduces interference in a cellular network by coordination of the phases applied to data transmissions across multiple base station sectors in a network. The coordination reduces the levels of interference seen by mobile devices, resulting in a gain in system capacity and improvement in cell edge performance.

Method of reducing interference in a cellular network by assigning fixed precoding matrices to be used on certain resource blocks and allowing any precoding matrix to be used on their resource blocks. Some of the concepts relevant to this disclosure are discussed in U.S. Pat. No. 8,412,246, Systems and Methods for Coordinating the Scheduling of Beamformed Data to Reduce Interference, and U.S. Pat. No. 8,737,926, Scheduling of Beamformed Data to Reduce Interference, each of which are incorporated by reference herein.

This disclosure provides a method and system for coordinating the phase applied to data transmissions across multiple base station sectors in a network. The coordination reduces the levels of interference seen by mobile devices, resulting in a gain in system capacity and improvement in cell edge performance. Embodiments are described in the context of LTE release 8/9, but can also be applied to other OFDMA based wireless protocols.

In an embodiment, when a base station is transmitting data to a mobile station, it can select an optimal phase adjustment to apply to its transmit signals so that the signals arrive at the mobile station with the best possible phase relationship. In addition, the interference seen by that mobile station can be reduced if the phases chosen by a neighboring base station are such that the interfering signals destructively interfere with each other as much as possible, resulting in a reduction in the interference levels.

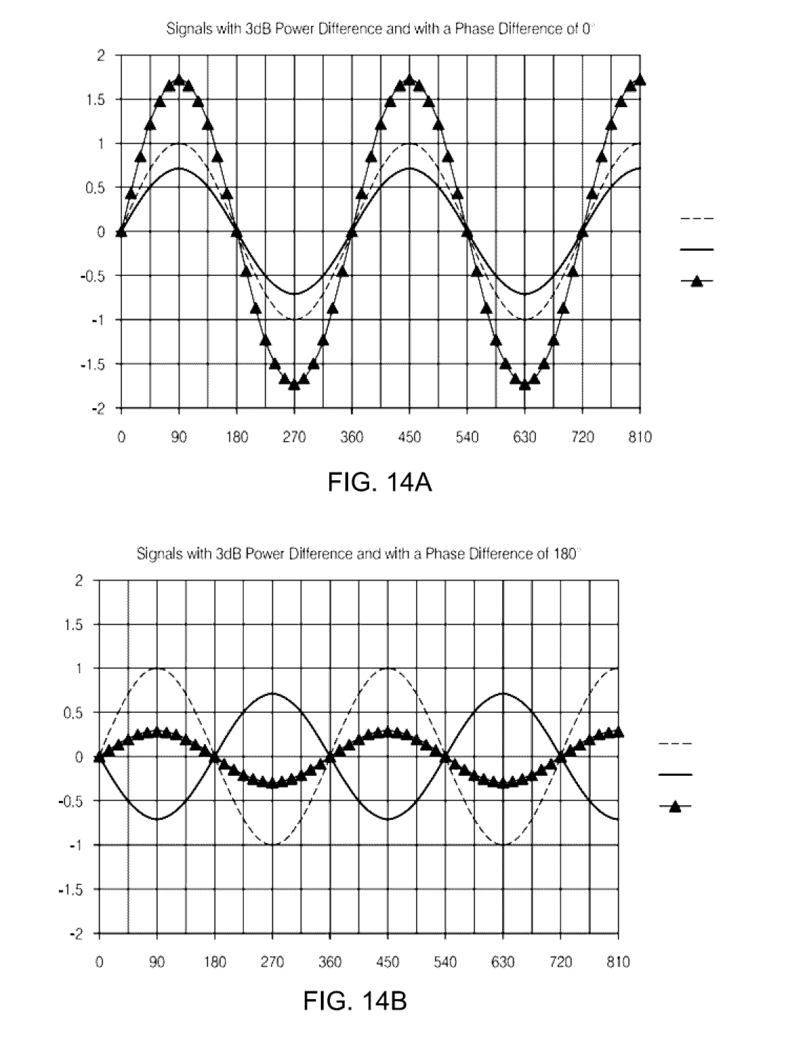

FIG. 14A and FIG. 14B show examples of two signals with different power levels being received at a mobile station receiver. FIG. 14A shows the case where the two signals are perfectly aligned with each other in phase, resulting in a much stronger received combined signal. FIG. 14B the case where the two signals are 180° out of phase with each other. In this case, the signals do not completely cancel each other out, but the combined signal at the receiver is still attenuated significantly when compared with the case of the two separate signals being aligned perfectly with each other.

It is not necessary that the signals arriving at the receiver be aligned exactly in phase in order for a combining gain in signal strength to be achieved. Likewise, it is not necessary that the signals be exactly 180° out of phase with each other to realize a signal cancellation. Nor is it required for the amplitudes of the two signals to be equal in order to achieve a benefit.

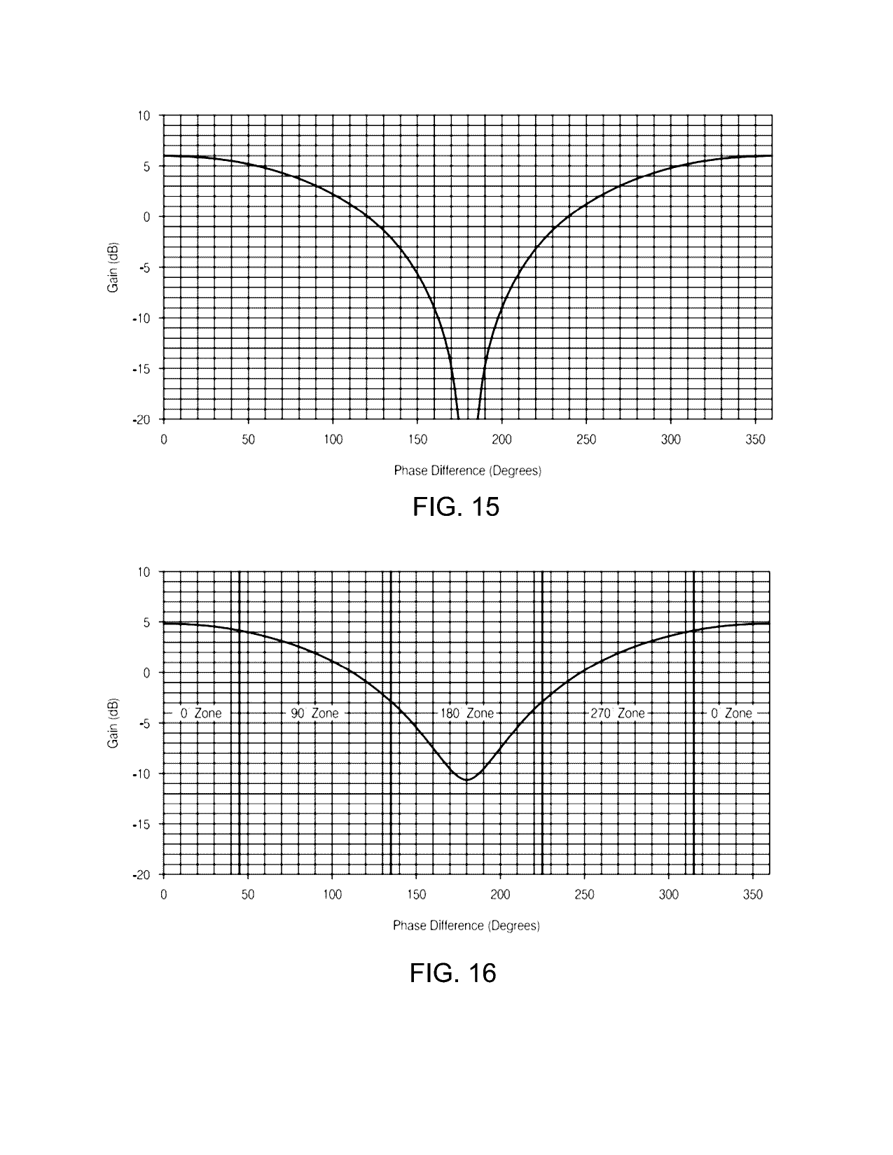

FIG. 15 shows a plot of the power gain of the combined signals, versus the phase difference of two signals at a receiver. It is assumed that both signals are received with equal amplitude. The gain is relative to a signal sent at a nominal level of 0 dB from one of the transmit antennas. The largest gain (6 dB) is seen when the two signals are perfectly aligned in phase, while the lowest gain (in this case, perfect cancellation) is seen when the signals have a phase difference of 180°.

When the signals are transmitted from a base station to a mobile station, the channel between the base station antennas and the mobile station antennas modifies the phase differences between the signals before they arrive at a mobile station antenna. Even if identical signals are transmitted from each base station antenna with the same phase, the signals arriving at the mobile station will generally not have the same phase. In order to improve the signal levels of the signals arriving at a mobile station from a serving base station, the mobile station can measure the phase differences of the signals arriving from each base station antenna, calculate an appropriate phase adjustment that maximizes the combined signal strength, then feed this information back to the serving base station so it can then apply an appropriate phase adjustment when it sends data to the mobile station.

An embodiment of this disclosure includes a two transmit antenna system with phase adjustments of 0 degrees, 90 degrees, 180 degrees and 270 degrees. In other words, phase may be adjusted in 90 degree steps and signaled by two data bits.

In the same manner that the strength of a desired signal from a serving base station can be maximized via appropriate selection of transmit phase adjustments, the strength of an undesired signal from an interfering base station can be reduced if the phase adjustment of the signals from the interfering base station are chosen appropriately. The choice of phase adjustment for signals originating from a serving base station is less critical than the choice of phase adjustments for signals originating from the interfering base stations. One of the phase adjustments from the interfering base station results in the greatest reduction in interference and subsequently the biggest improvement in CINR.

FIG. 16 shows the gain vs. phase difference when there is a 3dB imbalance in the signal levels arriving at the receiver. In this case, the gain is relative to the stronger of the two received signals.

FIG. 16 also shows four phase adjustment zones corresponding to phase adjustments of 0 degrees, 90 degrees, 180 degrees and 270 degrees. If the two signals arrive at the receiver with a phase difference that is between 135 degrees and 225 degrees (i.e., 180 degrees +/−45 degrees) then the interference level is minimized.

In the case of a mobile station with two or more receive antennas, the calculations performed to determine the appropriate phase adjustment for either the serving base station or the interfering base station are somewhat more complicated, but the basic principle still applies. In an embodiment, the mobile station decides on the ‘best’ phase adjustment to be applied by the serving base station and reports this data back to the base station. The ‘best’ phase adjustment may result in the best signal power as determined, for example, by a singular value decomposition of the channel matrix between the serving base station and the mobile station.

If a second base station is causing interference to the mobile station, the mobile station can also determine a ‘best’ phase adjustment to apply to the signals from the interfering base station. In such an embodiment, the ‘best’ phase adjustment may result in the least power as determined by a singular value decomposition of the channel matrix.

Note that the discussion above about achieving the best power or least interference assumes the transmission of a single stream of data (e.g., no Spatial Multiplexing (SM)). When there are multiple transmit antennas at a base station and multiple receive antennas at a mobile station, SM may also be a viable transmission option. In SM, multiple independent streams of data are transmitted from a base station simultaneously. In this case, different information symbols are transmitted from each base station antenna. With SM, it is generally not feasible to phase align the signals from each base station antenna to achieve either a boost or reduction in signal strength.

Nevertheless, if the serving base station is using spatial multiplexing to send data to a mobile device, an interference reduction can still be achieved if the interfering base station is transmitting the same data from each antenna—e.g., if it is not using spatial multiplexing. The phases of the signals transmitted from the interfering base station can still be adjusted to achieve an interference reduction at the mobile station served by the first base station.

In LTE, a macrocell base station may be referred to as the eNodeB and a mobile station may be referred to as User Equipment (UE). The LTE airlink is OFDMA based with a subcarrier spacing of 15 kHz. The basic unit of transmission is a resource block (RB), which consists of 12 subcarriers, adjacent in frequency. The bandwidth of a RB is therefore 180 kHz.

The LTE airlink is divided into timeslots of 1 ms each, known as Transmit Time Intervals (TTIs).

In one TTI, fourteen OFDM symbols are transmitted by an eNodeB. The basic unit of transmission form an eNodeB to a UE is therefore 12 subcarriers over 14 OFDM symbols. The eNodeB transmits data on one or more resource blocks to a UE. The UE periodically provides information on the number of spatial streams that can be used on groups of resource blocks via the Rank Indication (RI), as well as the modulation and coding scheme (MCS) to be applied to each spatial stream via the Channel Quality Index (CQI). Additionally, in closed loop MIMO (CL-MIMO), the UE informs the eNodeB of a preferred precoding matrix to be used, via the Precoding Matrix Indicator (PMI).

In the 2×2 CL-MIMO scheme, there are four precoding matrices if the rank index=1 and two precoding matrices if the rank index=2. For the purposes of interference reduction via phase coordination, the rank-one precoding matrices are the most appropriate.

The basic steps for CL-MIMO operation in LTE are as follows:
1. UE estimates channel matrix from serving eNodeB
2. UE determines appropriate Rank Index, Precoding Matrix and Channel Quality Indicator and feeds this information back to the eNodeB
3. The eNodeB can use the same precoding matrix as specified by the UE, or a different precoding matrix. Note that if a different precoding matrix is chosen by the eNodeB then a different CQI will likely have to be chosen also.
4. The eNodeB transmits data to the UE. The Downlink Channel Indicator (DCI) message send on the downlink control channel (PDCCH) indicates to the UE what PMI and CQI were used by the eNodeB for this transmission. The UE requires this information so that it can correctly equalize and demodulate the data transmitted by the eNodeB.

The four rank-one precoding matrices defined in LTE are:

$$( \begin{matrix}1 \\ 1\end{matrix} ) , ( \begin{matrix}1 \\ j\end{matrix} ) , ( \begin{matrix}1 \\ - 1\end{matrix} ) , ( \begin{matrix}1 \\ - j\end{matrix} )$$

These precoding matrices are equivalent to sending a data symbol on the first antenna and the same data symbol on the second antenna, but with a phase shift of 0, 90, 180 or 270 degrees respectively. In LTE terminology, applying a phase adjustment is equivalent to selecting a precoding matrix.

Note that the precoding matrices above are for rank-one transmission only. For rank-two transmissions (spatial multiplexing) a different set of two precoding matrices are used. As discussed previously, if a UE indicates that the eNodeB should use two transmission streams from the serving eNodeB then the performance of the rank-2 transmission can still benefit from the choice of an optimal rank-1 precoding matrix on the same RBs from the interfering eNodeB.

For simplification, the scaling factor of 1/sqrt(2) is omitted from this discussion, which does not impact the phase adjustments of the precoding matrices.

In an embodiment, a UE feeds back information to a serving eNodeB about the optimal phase adjustment for the serving eNodeB, as well as the optimal phase adjustments that result in the greatest levels of signal cancellation from neighboring eNodeBs. While LTE supports the PMI feedback for the serving eNodeB, it does not support any such feedback about an appropriate PMI to be used at a neighboring eNodeB.

However, if the phase adjustment applied to certain resource blocks at an interfering eNodeB can be fixed for a period of time (e.g., 100 ms or more) then reductions in interference are still possible.

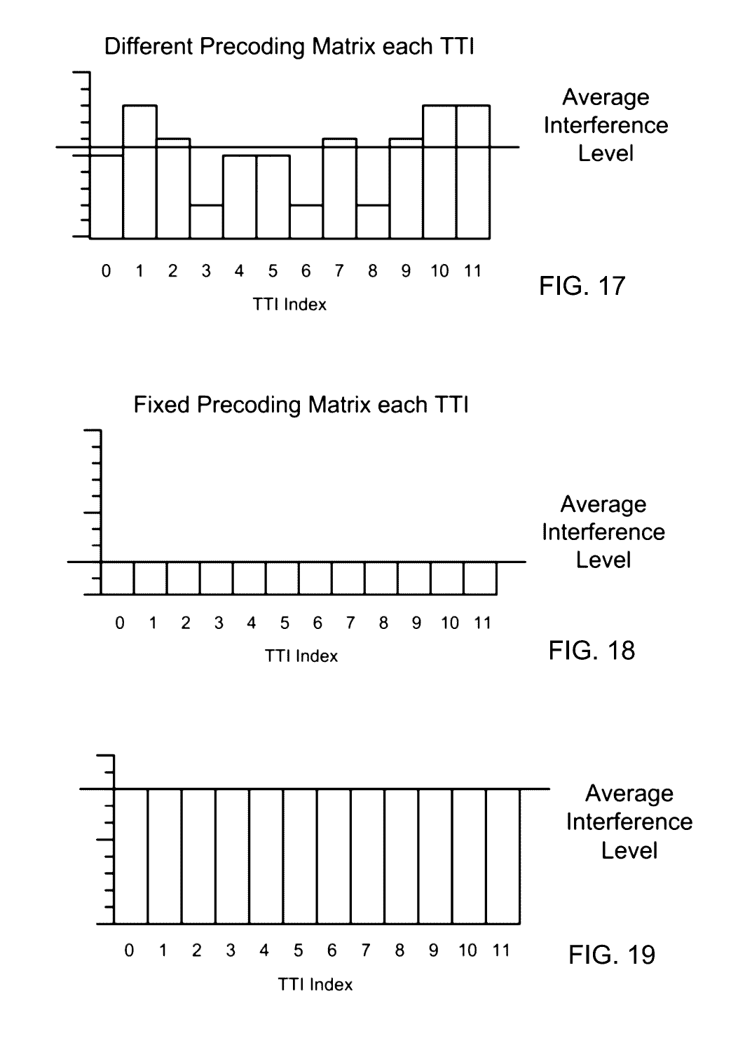

Normally, an eNodeB may choose any precoding matrix when transmitting data on a given RB in a given TTI. In this case, if these transmissions are causing interference to a UE being served by a second eNodeB, the interference levels seen by the UE will change from TTI to TTI. Since the interfering eNodeB can choose a different precoding matrix for a given RB in each TTI, the phase differences between the signals arriving at the UE experiencing the interference are constantly changing. The net effect is that the instantaneous interference level in each TTI varies, depending on the precoding matrix chosen by the interfering eNodeB for each TTI, as seen in FIG. 17.

When a UE is estimating the CQI that can be used for transmission, it makes an estimate of the amount of interference plus noise that it sees in each resource block. If the UE uses an instantaneous measurement of interference plus noise from a single RB then it may select an inaccurate CQI. Generally, the UE will perform some amount of averaging of the noise over multiple RBs in order to arrive at a suitable CQI that should be used by the eNodeB when sending data to the UE. The averaging may be over the most recent N TTIs, where N is either a fixed amount of TTIs (e.g., 5 or 10), or may be an exponentially weighted average with appropriate weights.

If an eNodeB is configured to always use the same rank-one precoding matrix on a given resource block then the situation changes. If a UE is stationary, or moving slowly (e.g., pedestrian speeds), then the interference levels essentially remains constant from TTI to TTI, as shown in FIG. 18 and FIG. 19 in two separate scenarios.

If the UE is moving quickly then the motion of the UE can cause the phase differences of the received signals to vary from TTI to TTI, so the situation is essentially the same as that shown in FIG. 17, with varying interference power levels from TTI to TTI.

Therefore, for low mobility UEs, a slowly changing interference power situation can permit additional gains in performance. If the fixed phases at the interfering eNodeB are such that the interference experienced by a UE is low in a group of resource blocks, then the standard CQI reporting mechanism will indicate to the serving eNodeB that it can use a higher CQI when transmitting data to that UE. In some cases, the interference levels may be reduced to the point that the UE can switch to spatial multiplexing on that group of resources, for even higher performance.

Note that if the precoding matrix is fixed for a particular group of resources, a given UE may or may not see a reduced level of interference. Nevertheless, over the entire population of UEs, approximately 50% will see a reduction in average interference levels on a given RB while the remaining UEs will see an increase in average interference on that RB.

If the precoding matrices are fixed across multiple RBs on an interfering eNodeB then at a UE experiencing the interference, it should expect to see a reduction in average interference plus noise in approximately 50% of the RBs and in increase in average interference plus noise in the remaining RBs.

For the baseline coordinated phase scheduling algorithm, the airlink is divided into two sections:
1. Resource blocks with a fixed precoding matrix
2. Resource blocks with a variable precoding matrix

The assignment of fixed/variable precoding matrices to a resource block varies from base station to base station sector. In a simple case, a fixed assignment is applied at each base station sector. It is important that at least some of the RBs with variable PMI are aligned in frequency with RBs with a fixed PMI on neighboring eNodeBs. An example of an assignment across three base station sectors is shown in the following Table 1:

TABLE 1
Example assignment of fixed and variable precoding matrices

| | RB Index | | | | | | | | |
|---|---|---|---|---|---|---|---|---|---|
| | 0-5 | 6-11 | 12-17 | 18-23 | 24-29 | 30-35 | 36-41 | 42-47 | 48-49 |
| eNodeB | V | F | F | V | F | F | V | V | V |
| #1 | | (0) | (90) | | (180) | (270) | | | |
| eNodeB | F | V | F | F | V | F | V | V | V |
| #2 | (270) | | (0) | (90) | | (180) | | | |
| eNodeB | F | F | V | F | F | V | V | V | V |
| #3 | (180) | (270) | | (0) | (90) | | | | |

When an eNodeB is transmitting on a resource block with a fixed precoding matrix, it uses that PMI for that resource block. By doing so, UEs attached to neighboring eNodeBs will experience a more consistent level of interference on those resources. For some UEs, the phase adjustments result in a slightly higher than average level of interference. For other UEs though, the levels of interference can be significantly reduced as a result of the phase cancellation from the neighboring eNodeB.

If a UE sees a lower interference plus noise level on a given RB, it will indicate a higher order CQI to its serving eNodeB. With the assumption that a frequency selective scheduler is being used by the eNodeB, the scheduler will preferentially select those RBs when transmitting data to the UE.

There are no restrictions on which UE can be transmitted to using a RB on which a variable precoding matrix can be used. There are also no restrictions on the rank of transmissions on these RBs—if a UE indicates rank 2 transmissions for these RBs then the serving eNodeB should schedule accordingly.

Since the precoding matrix is fixed for some RBs, ideally only transmissions to UEs that report the same precoding matrix as the fixed precoding matrix would be scheduled on these resources. If there are a sufficiently large number of UEs being serviced by an eNodeB then it could be expected that there will always be at least a few UEs that report back to the eNodeB that they prefer to use the same PMI as the fixed precoding matrix for a given group of RBs.

However, RBs with a fixed precoding matrix could also be used to transmit data to UEs that report alternative PMI indices that have phase adjustments of either +/−90 degrees away from that of the fixed precoding matrix. The precoding matrix reported by the UE will not be used—the fixed precoding matrix will be used. Since the optimum precoding matrix is not used, it may be necessary to reduce the CQI level for those transmissions by one CQI step. Alternately, the reported CQI could still be used, with a slightly higher HARQ retransmission rate.

For optimal performance, it would not be expected that any data would be scheduled for any UE reporting a PMI with a phase adjustment that is 180 degrees from the fixed PM. If need be, for the purposes of calculating weights for a proportional fair scheduler, the CQI reported by the UE to the eNodeB for this resource block could be dropped by three to five levels. This would discourage the proportional fair scheduler from utilizing those RBs for that UE, but leave the possibility open that the UE could still possibly end up using those RBs if they are selected by the scheduler weighting process.

There are several ways in which RBs can be configured to use either a fixed precoding matrix, or the PM indicated by the PMI feedback from the UEs.

The simplest assignment of variable/fixed precoding matrices to RBs is via a static configuration. One way to implement a static configuration is to simply define a number of allocation patterns and assign them to different eNodeBs. Three such patterns are shown in Table 1 above. These three patterns could be reused throughout a network of eNodeBs in a similar fashion to a reuse of three frequency assignment pattern.

In the static configuration, the selection of which precoding matrices is to be assigned to a fixed precoding matrix RB group can be done randomly, or the same precoding matrix can be assigned to each RB group, or the precoding matrix can be assigned in an incremental fashion from RB group to RB group.

The variable/fixed precoding matrix configuration can also be changed in a dynamic fashion in several ways.

An embodiment may change the fixed/variable assignment pattern and/or the number of RBs that have a fixed precoding matrix assigned to them, based on interference patterns:
a. Collect information at each eNodeB in a network about the number of UEs that are experiencing interference, the levels of interference seen at each UE and the amount of data being sent to each UE.
b. This data can then be collected at a central controller that analyzes the interference information among all eNodeBs in the network and assigns a fixed/variable precoding matrix pattern to each eNodeB. At each eNodeB, the number of RBs with fixed precoding matrix assignments can be changed based on the number of UEs for which the eNodeB is causing interference. The amount of traffic being sent to the interfered UEs can also be used to decide the number of fixed precoding matrix RBs.

An embodiment may modify the fixed precoding matrix assignments based on how well they can reduce interference. In this case the precoding matrix assigned to a fixed precoding matrix RB is determined by analyzing information from the UEs about the optimal precoding matrices from their point of view.
a. Collect information from each UE about the optimal phase adjustment to reduce the levels of interference from interfering eNodeBs. b. Analyze the information (either at a central node or each eNodeB) to determine if there are any dominant phase adjustments that then can be assigned by interfering eNodeBs.
c. Assign the best precoding matrix to each group of fixed precoding matrix RBs.
d. Depending on how quickly the channel conditions are changing at each UE, the rate at which the above steps occur may change.

An example of an optimized set of phase assignments is shown in Table 2. The number of RBs with fixed precoding matrix assignments is different for each eNodeB. Also, the alignment of the RBs with fixed and variable precoding matrices is varied across the eNodeBs.

TABLE 2
Example optimized phase assignment table

| | RB Index | | | | | | | | |
|---|---|---|---|---|---|---|---|---|---|
| | 0-5 | 6-11 | 12-17 | 18-23 | 24-29 | 30-35 | 36-41 | 42-47 | 48-49 |
| eNodeB | V | F | V | V | F | V | V | F | V |
| #1 | | (90) | | | (180) | | | (0) | |
| eNodeB | F | V | F | F | F | V | V | V | V |
| #2 | (0) | | (0) | (90) | (90) | | | | |
| eNodeB | F | V | V | F | V | V | V | F | V |
| #3 | (180) | | | (180) | | | | (270) | |

The phase coordination algorithms disclosed in this paper can also be used in conjunction with other interference reduction techniques. For example, fixed precoding mapping can be overlaid on the resource block power allocations in a fractional frequency reuse scheme. In Fractional Frequency Reuse (FFR), different powers are allocated to different resource blocks. The power allocation pattern is varied from eNodeB to eNodeB. The power allocation pattern can be preprovisioned or can change dynamically.

Since cell edge users will generally be allocated higher transmit power resources in a FFR scheme, the RBs that are assigned a fixed precoding matrix will generally be those that are allocated a higher transmit power in the FFR scheme.

What is claimed is:

1. A method for optimizing parameters of a communication network, the method comprising:
receiving first information from a first network resource;
receiving second information from a second network resource;
comparing the first information to the second information; and
optimizing a network parameter based on a result of the comparison.
